(19) United States
(12) Patent Application Publication
(10) Pub. No.: US 2017/0323427 A1
(43) Pub. Date: Nov. 9, 2017

(54) METHOD FOR OVERLAPPING IMAGES

(71) Applicant: METAL INDUSTRIES RESEARCH & DEVELOPMENT CENTRE, Kaohsiung City (TW)

(72) Inventors: JINN-FENG JIANG, KAOHSIUNG CITY (TW); SHIH-CHUN HSU, KAOHSIUNG CITY (TW); HUNG-YUAN WEI, KAOHSIUNG CITY (TW); TSUNG-HAN LEE, KAOHSIUNG CITY (TW); TSU-KUN CHANG, KAOHSIUNG CITY (TW); TIEN-SZU PAN, KAOHSIUNG CITY (TW)

(21) Appl. No.: 15/586,606

(22) Filed: May 4, 2017

(30) Foreign Application Priority Data
May 6, 2016 (TW) 105114235

(51) Int. Cl. G06T 3/40; G01C 11/02; G06T 7/13; H04N 5/232

(52) U.S. Cl. CPC G06T 3/4038; H04N 5/23238; G01C 11/02; G06T 7/13; B60R 2300/105; B60R 2300/202; B60R 2300/304; B60R 2300/303

(57) ABSTRACT

A method for overlapping images is revealed. After overlapping the overlapped regions in two depth images generated by structured-light camera units, a first image, the overlapped image, and a fourth image are display on a display unit. Thereby, the drivers' viewing ranges blocked by the vehicle body while viewing outwards from the interior of a vehicle can be retrieved. Then the drivers' blind spots can be minimized and thus improving driving safety.

### TECHNICAL FIELD

The present disclosure relates generally to a method for overlapping images, and particularly to a method for overlapping images according to the overlapped image of the stable extremal regions of two structured light images.

### DESCRIPTION OF THE RELATED ART

Nowadays, automobiles are the most common vehicles in daily life. They include, at least, left side, right side, and rearview mirrors for reflecting the rear left, rear right, and rear images to the drivers of automobiles. Unfortunately, the viewing ranges provided by the mirrors are limited. For providing broader viewing ranges, convex mirrors must be adopted. Nonetheless, the images formed by convex mirrors are shrunk erect virtual images, which lead to illusions that the objects appear farther on the mirrors. Consequently, the drivers are difficult to estimate the distances to objects well.

As automobiles are running on roads, in addition to limited viewing ranges and errors in distance estimation, the safety of drivers, passengers, and pedestrians can more possibly be threatened due to spiritual fatigue and disobeyance of others. To improve safety, some passive safety equipment has become standard equipment. In addition, active safety equipment is being developed by the automobile manufacturers.

In current technologies, there exist alarm apparatuses capable of submitting warnings real-timely for drivers' safety. For example, signal transmitters and receivers can be disposed and used as reversing radars. When other objects approach the back of the automobile, sound will be transmitted to remind drivers. Unfortunately, for drivers, there still exist some specific blind spots. Therefore, cameras are usually disposed in automobiles for assisting driving.

Currently, cameras are frequently applied to assisting driving. Normally, multiple cameras are disposed to the front, rear, left, and right of an automobile to take images surrounding the automobile for assisting a driver to avoid accidents. However, it is difficult for a driver to watch multiple images simultaneously. Besides, the blind spots of planar images in driving assistance are still significant. Thereby, some manufacturers combine the multiple images acquired using the cameras disposed on a car to form a pantoscopic image. This fits the visual customs of human eyes and eliminates the blind spots.

Unfortunately, the images taken by cameras are planar images. It is difficult for a driver to detect the distance to an object according the images. Some vendors add reference lines into the images for distance judgement. Nonetheless, the driver obtains a rough estimation from the distance judgement only.

Accordingly, the present disclosure provides a method for overlapping images according to the characteristic values of the overlapped regions in two structured light images. In addition to eliminating the blind spots according to the overlapping images, the driver can know the distance between the vehicle and an object according to the depth in the image.

### SUMMARY

An objective of the present disclosure is to provide a method for overlapping images. After overlapping the overlapped regions in two depth images generated by structured-light camera units, a first image, the overlapped image, and a fourth image are shown on a display unit. Thereby, the drivers' viewing ranges blocked by the vehicle body while viewing outwards from the interior of a vehicle can be retrieved. Then the drivers' blind spots can be minimized and thus improving driving safety.

In order to achieve the above objective and efficacy, the method for overlapping images according to an embodiment of the present disclosure comprises steps of generating a first depth image using a first structured-light camera unit and generating a second depth image using a second structured-light camera unit, acquiring a first stable extremal region of a first image and a second stable extremal region of a third image according to a first algorithm; and overlapping a second image and the third image to generate a first overlapped image, and displaying the first image, the first overlapped image and a fourth image on a display unit when the first stable extremal region and the second stable extremal region match.

According to an embodiment of the present disclosure, the method further comprises a step of setting the overlapped portion in the first depth image with the second depth images as the second image and setting the overlapped portion in the second depth image with the first depth images as the third image according to the angle between the first structured-light camera unit and the second structured-light camera unit.

According to an embodiment of the present disclosure, the first algorithm is the maximally stable extremal regions (MSER) algorithm.

According to an embodiment of the present disclosure, the method further comprises a step of processing the first stable extremal region and the second stable extremal region using an edge detection algorithm before generating the overlapped depth image.

According to an embodiment of the present disclosure, the method further comprises steps of: acquiring a first color image and a second color image; acquiring a first stable color region of a sixth image and a second stable color region of a seventh image in the first color image using a second algorithm; when the first stable color region and the second stable region match, overlapping the sixth image and the seventh image to generate a second overlapped image, and displaying a fifth image, the second overlapped image, and an eighth image on the display unit.

According to an embodiment of the present disclosure, before generating the overlapped image, the method further comprises a step of processing the first stable color region and the second stable color region using an edge detection algorithm.

According to an embodiment of the present disclosure, further comprising a step of setting the overlapped portion in the first color image with the second color images as the sixth image and setting the overlapped portion in the second color image with the first color images as the seventh image according to the angle between the first structured-light camera unit and the second structured-light camera unit.

According to an embodiment of the present disclosure, the method further comprises a step of processing the first stable color region and the second stable color region using an edge detection algorithm before generating the overlapped depth image.

According to an embodiment of the present disclosure, the second algorithm is the maximally stable color regions (MSCR) algorithm.

### BRIEF DESCRIPTION OF THE DRAWINGS

FIG. 1 shows a flowchart of the method for overlapping images according to the first embodiment of the present disclosure;

FIG. 2 shows a schematic diagram of the camera device in the method for overlapping images according to the first embodiment of the present disclosure;

FIG. 3 shows a schematic diagram of the application of the method for overlapping images according to the first embodiment of the present disclosure, used for illustrating projecting light planes on an object;

FIG. 4 shows a schematic diagram of the two-dimensional dot matrix of a light plane in the method for overlapping images according to the first embodiment of the present disclosure;

FIG. 5A shows a schematic diagram of disposing the camera devices to the exterior of a vehicle in the method for overlapping images according to the first embodiment of the present disclosure;

FIG. 5B shows a schematic diagram of disposing the camera devices to the interior of a vehicle in the method for overlapping images according to the first embodiment of the present disclosure;

FIG. 5C shows a system schematic diagram of the method for overlapping images according to the first embodiment of the present disclosure;

FIG. 5D shows a schematic diagram of the angle between the camera devices in the method for overlapping images according to the first embodiment of the present disclosure;

FIG. 6A shows a schematic diagram of the first depth image in the method for overlapping images according to the first embodiment of the present disclosure;

FIG. 6B shows a schematic diagram of the second depth image in the method for overlapping images according to the first embodiment of the present disclosure;

FIG. 6C shows a schematic diagram of the first reginal depth characteristic vales of the first depth image in the method for overlapping images according to the first embodiment of the present disclosure;

FIG. 6D shows a schematic diagram of the second reginal depth characteristic vales of the second depth image in the method for overlapping images according to the first embodiment of the present disclosure;

FIG. 6E shows a schematic diagram of overlapping images in the method for overlapping images according to the first embodiment of the present disclosure;

FIG. 7 shows a schematic diagram of the camera device in the method for overlapping images according to the second embodiment of the present disclosure;

FIG. 8A shows a schematic diagram of the first image in the method for overlapping images according to the second embodiment of the present disclosure;

FIG. 8B shows a schematic diagram of the second image in the method for overlapping images according to the second embodiment of the present disclosure;

FIG. 8C shows a schematic diagram of the third reginal depth characteristic vales of the first image in the method for overlapping images according to the second embodiment of the present disclosure;

FIG. 8D shows a schematic diagram of the fourth reginal depth characteristic vales of the second image in the method for overlapping images according to the second embodiment of the present disclosure;

FIG. 8E shows a schematic diagram of overlapping images in the method for overlapping images according to the second embodiment of the present disclosure;

FIG. 9 shows a flowchart of the method for overlapping images according to the third embodiment of the present disclosure;

FIG. 10A shows a schematic diagram of the first depth image in the method for overlapping images according to the fourth embodiment of the present disclosure;

FIG. 10B shows a schematic diagram of the second depth image in the method for overlapping images according to the fourth embodiment of the present disclosure;

FIG. 10C shows a schematic diagram of the overlapped depth image in the method for overlapping images according to the fourth embodiment of the present disclosure;

FIG. 11A shows a schematic diagram of the first depth image in the method for overlapping images according to the fifth embodiment of the present disclosure;

FIG. 11B shows a schematic diagram of the second depth image in the method for overlapping images according to the fifth embodiment of the present disclosure;

FIG. 11C shows a schematic diagram of the overlapped depth image in the method for overlapping images according to the fifth embodiment of the present disclosure; and

FIG. 12 shows a schematic diagram of the overlapped depth image in the method for overlapping images according to the sixth embodiment of the present disclosure.

### DETAILED DESCRIPTION

In order to make the structure and characteristics as well as the effectiveness of the present disclosure to be further understood and recognized, the detailed description of the present disclosure is provided as follows along with embodiments and accompanying figures.

According to the prior art, the combined image of the multiple images taken by a plurality of cameras disposed on a vehicle is a pantoscopic image. This fits to the visual customs of humans and solves the problem of blind spots. Nonetheless, the images taken by the plurality of cameras are planar images. It is difficult for drivers to estimate the distance to an object according to planar images. Thereby, a method for overlapping images according to extremal regions in the overlapped regions of two structured-light images is provided in this disclosure. In addition, the pantoscopic structured-light image formed by overlapping two structured-light images can also overcome the blind spots while a driver driving a vehicle.

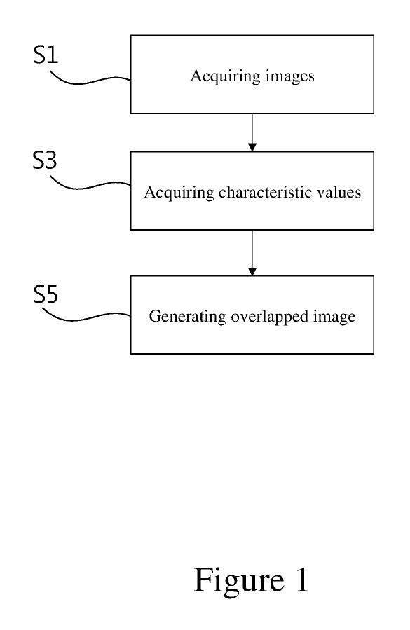

In the following, the process of the method for overlapping images according to the first embodiment of the present disclosure will be described. Please refer to FIG. 1, which shows a flowchart of the method for overlapping images according to the first embodiment of the present disclosure. As shown in the figure, the method for overlapping images according to the present embodiment comprises steps of:
Step S1: Acquiring images;
Step S3: Acquiring characteristic values; and
Step S5: Generating an overlapped image.

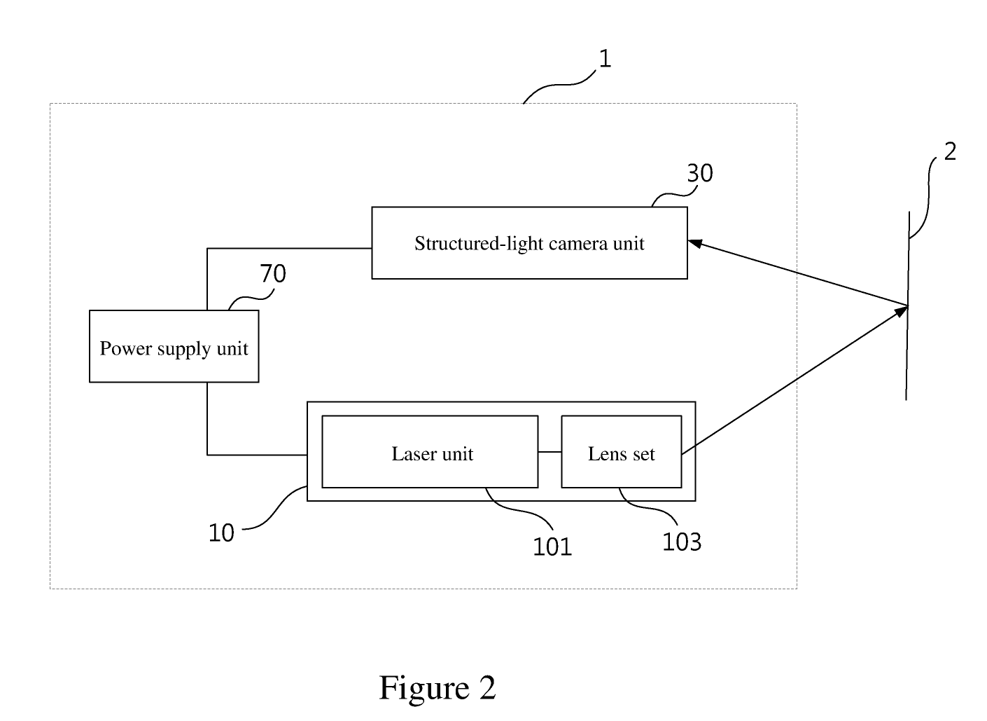

Next, the system required to implement the method for overlapping images according to the present disclosure will be described below. Please refer to FIGS. 2, 3, 4, and 5. According to the method for overlapping image of the present disclosure, two camera devices 1 should be used. The camera device 1 includes a structured-light projecting module 10 and a structured-light camera unit 30. The above unit and module can be connected electrically with a power supply unit 70 for power supplying and operating.

The structured-light projecting module 10 includes a laser unit 101 and a lens set 103, used for detecting if objects, such as pedestrians, animals, other vehicles, immobile fences and bushes, that may influence driving safety exist within tens of meters surrounding the vehicle, and detecting the distances between the vehicle and the objects. The detection method adopted by the present disclosure is to use the structured light technique. The principle is to project controllable light spots, light stripes, or light planes to a surface of the object under detection. Then sensors such as cameras are used to acquire the reflected images. After geometric calculations, the stereoscopic coordinates of the object can be given. According to a preferred embodiment of the present disclosure, the invisible laser is adopted as the light source. The invisible laser is superior to normal light due to its high coherence, slow attenuation, long measurement distance, high accuracy, and resistance to the influence by other light sources. After the light provided by the laser unit 101 is dispersed by the lens set 103, it becomes a light plane 105 in space. As shown in FIG. 4, the lens set 103 according to the present disclosure includes a pattern lens, which owns patterned micro structures to make the light plane 105 formed by the penetrating laser light have patterned characteristics. For example, the patterned characteristics include the light-spot matrix in two dimensions.

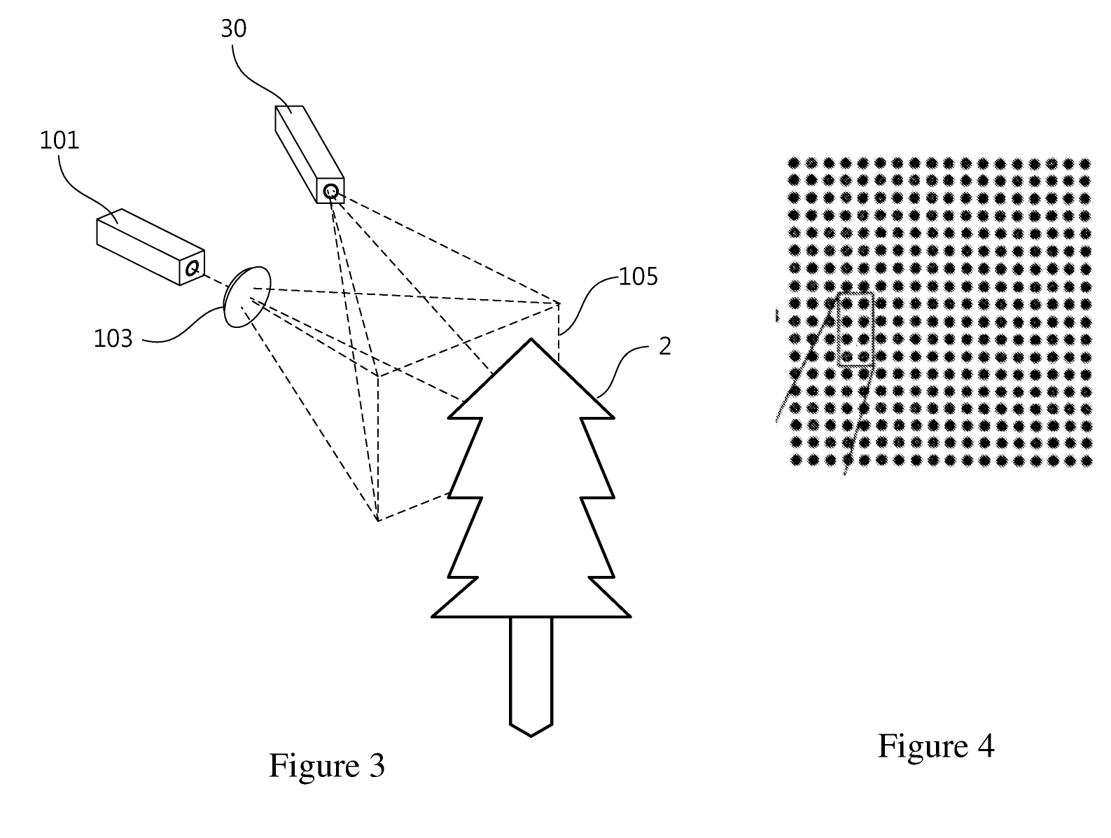

As shown in FIG. 3, if there is another object 2 around the vehicle, when the light plane 105 is projected onto a surface of the object 2, the light will be reflected and received by the structured-light camera unit 30 in the form of light pattern message. The structured-light camera unit 30 is a camera unit capable of receiving the invisible laser light. The light pattern message is a deformed pattern formed by the light plane 105 reflected irregularly by the surface of the object 2. After the structured-light camera unit 30 receives the deformed pattern, the system can further use this deformed pattern to obtain the depth value of the object 2. Namely, the distance between the object 2 and the vehicle can be known. Thereby, the stereoscopic outline of the object 2 can be reconstructed and hence giving a depth image.

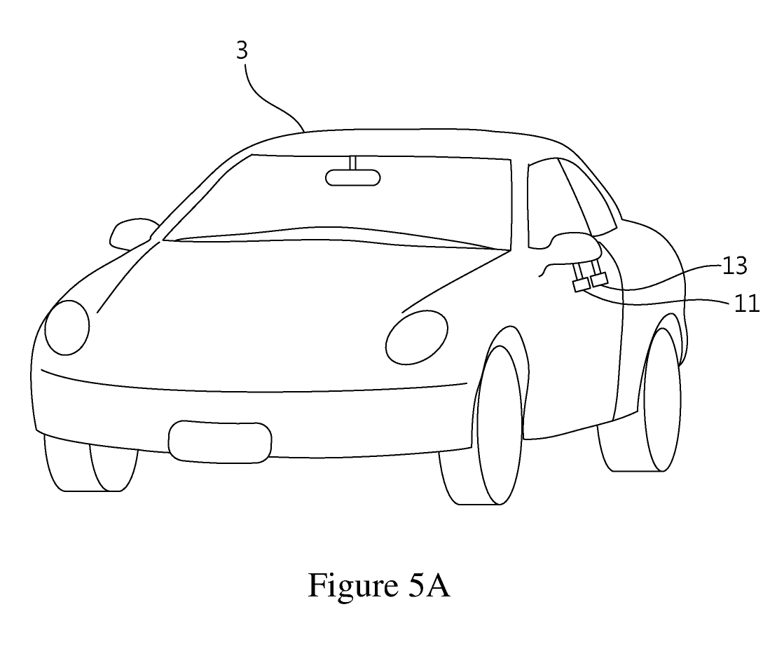

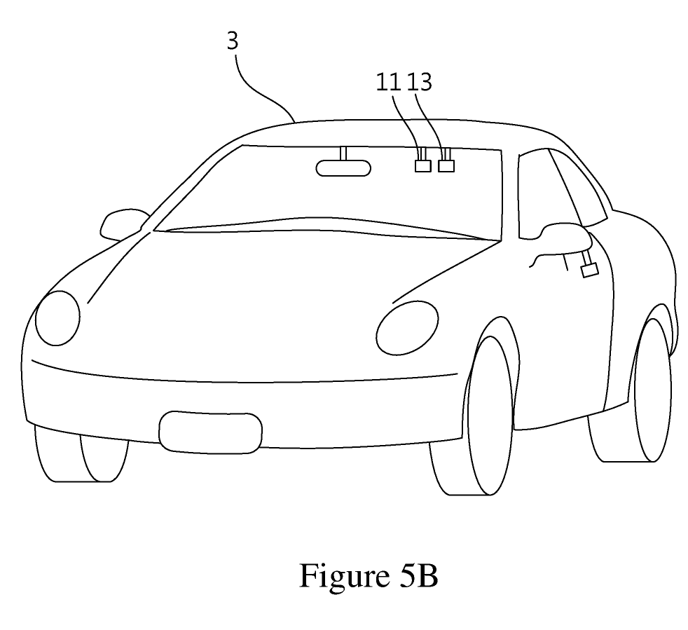

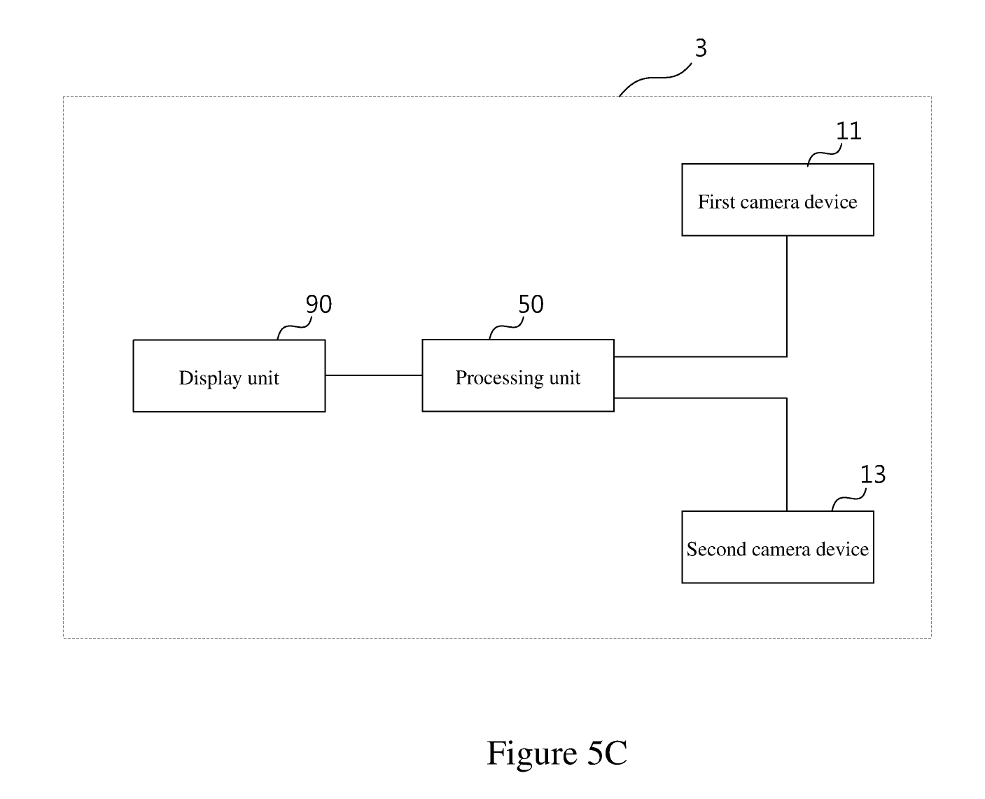

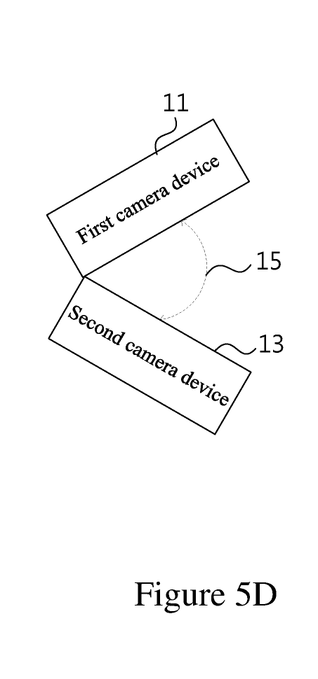

As shown in FIGS. 5A and 5B, while using the method for overlapping images according to the first embodiment of the present disclosure, a first camera device 11 and a second camera device 13 are disposed to the exterior (FIG. 5A) or the interior (FIG. 5) of a vehicle 3. As shown in FIG. 5C, the first camera device 11 and the second camera device 13 are connected to a processing unit 50, which is connected to a display unit 90. When the first and second camera devices 11, 13 are disposed to the interior, their respective structured-light projecting module 10 projects structured light outwards from the windshield or windows of the vehicle 3. The light plane will be reflected by the neighboring objects and received by the structured-light camera unit 30. The vehicle 3 can be a minibus, a truck, or a bus. As shown in FIG. 5D, the first and second camera devices 11, 13 are disposed at an angle 15. Thereby, the image taken by the first camera device 11 overlaps partially with the one taken by the second camera device 13.

As shown in FIGS. 5C, the processing unit 50 is an electronic device capable of performing arithmetic and logic operations. The display unit 90 can be liquid crystal display, a plasma display, a cathode ray tube, or other display units capable of displaying images.

In the following, the process of implementing the method for overlapping images according to the first embodiment of the present disclosure will be described. Please refer to FIGS. 1, 2, 5A, 5B, 5C, and 6A˜6E. As the vehicle 3 moves on a road with the first and second camera devices 11, 13 disposed at the angle 15, the system for overlapping images according to the present disclosure will execute the steps S1 to S5.

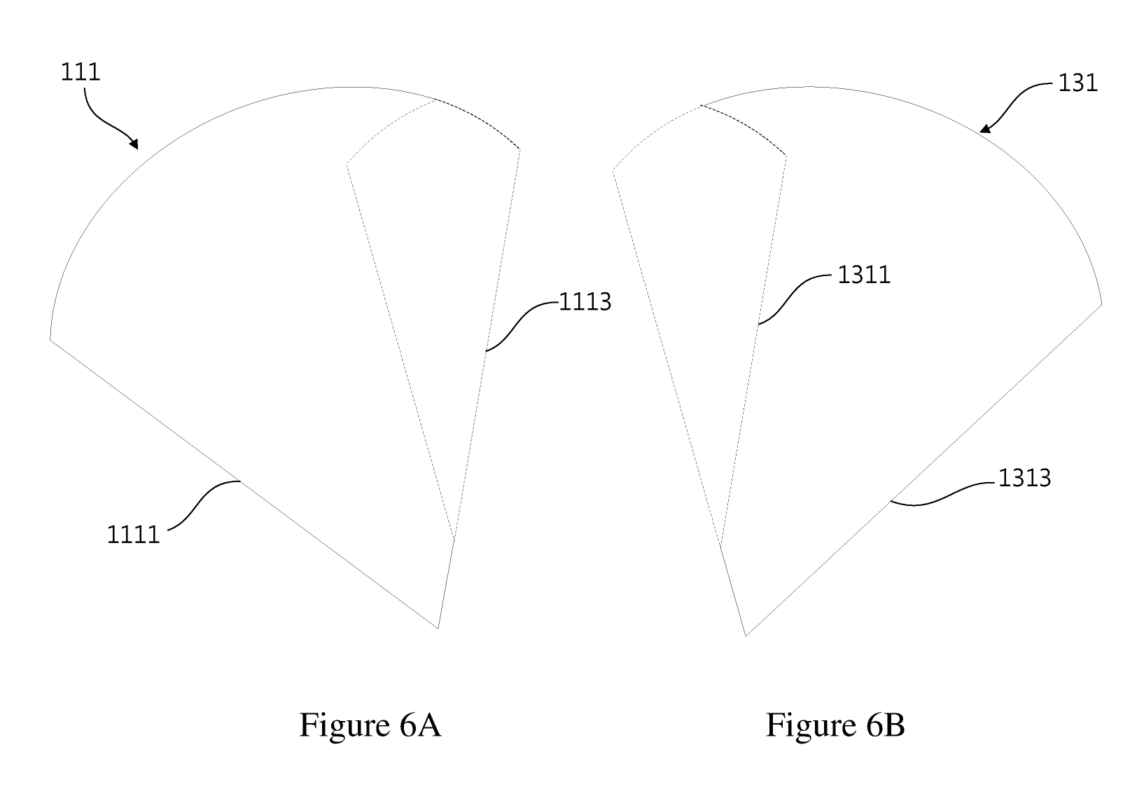

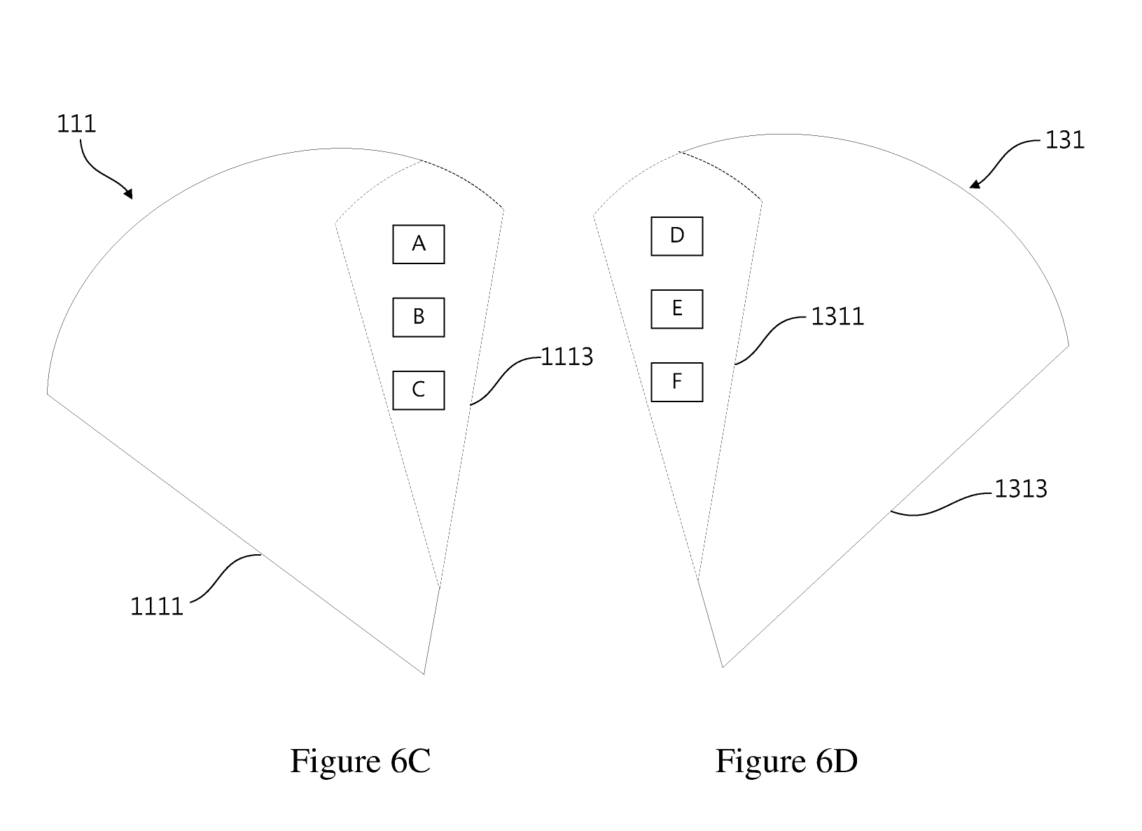

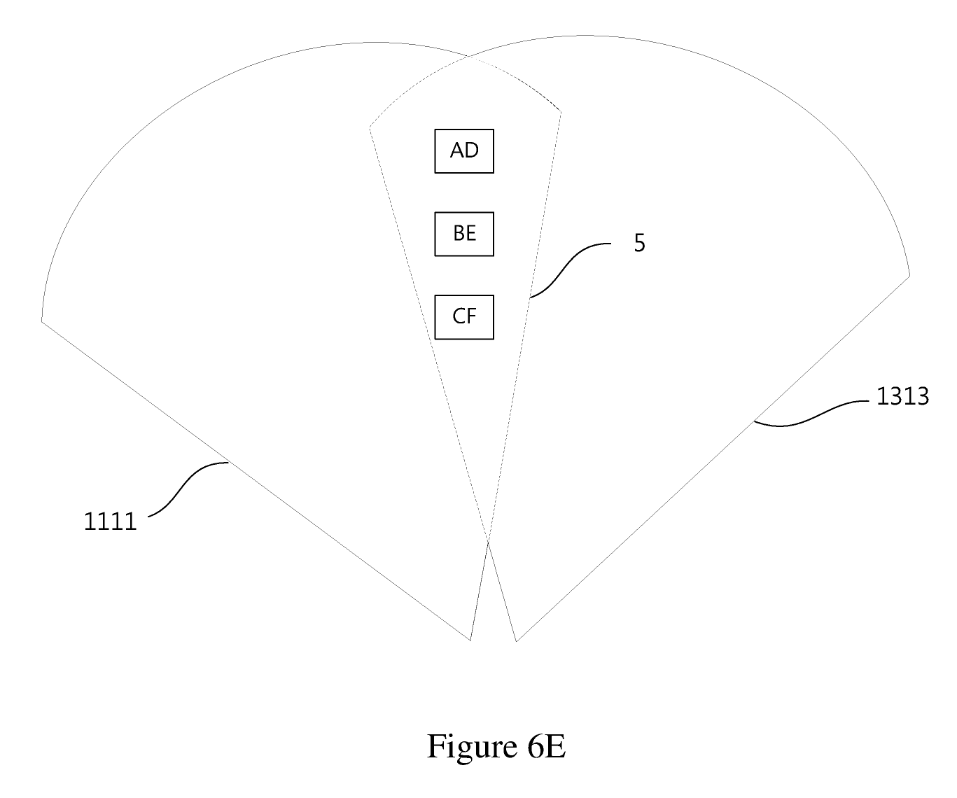

The step S1 is to acquire images. After the structured-light projecting module 10 of the first camera device 11 projects the structured light, the structured-light camera unit 30 (the first structured-light camera unit) of the first camera device 11 receives the reflected structured light and generates a first depth image 111. Then the structured-light projecting module 10 of the second camera device 13 projects the structured light, the structured-light camera unit 30 (the second structured-light camera unit) of the second camera device 13 receives the reflected structured light and generates a second depth image 131. The first depth image 111 and the second depth image 131 overlap partially. As shown in FIG. 6A, the first depth image 111 includes a first image 1111 and a second image 1113. As shown in FIG. 6B, the second depth image 131 includes a third image 1311 and a fourth image 1313.

The step S3 is to acquire characteristic values. The processing unit 50 adopts the maximally stable extremal regions (MSER) algorithm to calculate the second image 1113 for giving a plurality of first stable extremal regions, and calculate the third image 1311 for giving a plurality of second stable extremal regions. According to the MSER algorithm, an image is first converted to a greyscale image. Set the values 0˜255 as the threshold value, respectively. The pixels with the pixel values greater than the threshold value are set as 1, while those with the pixel values less than the threshold value are set as 0. 256 binary images according to the threshold values will be generated. By comparing the image regions of neighboring threshold values, the relations of threshold variations among regions, and hence the stable extremal regions, can be given. For example, as shown in FIG. 6C, the first stable extremal region A, the first stable extremal region B, and the first stable extremal region C in the second image 1113 are given using the MSER algorithm. As shown in FIG. 6D, the second stable extremal region D, the second stable extremal region E, and the second stable extremal region F in the third image 1311 are given using the MSER algorithm.

The step S5 is to generate an overlapped image. The processing unit 50 matches the first stable extremal regions A˜C of the second image 1113 to the second stable extremal regions D˜F of the third image 1311. The processing unit 50 can adopt the k-dimensional tree algorithm, the brute force algorithm—the BBF (Best-Bin-First) algorithm or other matching algorithms for matching. When the first stable extremal regions A˜C match the second stable extremal regions D˜F, overlap the second image 1113 and the third image 1311 to generate a first overlapped image 5. As shown in FIGS. 6C to 6E, the first stable extremal region A matches the second stable extremal region D; the first stable extremal region B matches the second stable extremal region E; and the first stable extremal region C matches the second stable extremal region F. Accordingly, the processing unit 50 overlaps the second depth image 1113 and the third image 1311. It overlaps the first stable extremal region A and the second stable extremal region D to generate the stable extremal region AD; it overlaps the first stable extremal region B and the second stable extremal region E to generate the stable extremal region BE; and it overlaps the first stable extremal region C and the second stable extremal region F to generate the stable extremal region CF.

Because the first camera device 11 includes the first structured-light camera unit and the second camera device 13 includes the second structured-light camera unit, the processing unit 50 sets the overlapped portion in the first depth image 111 with the second depth image 131 as the second image 1113 and sets the overlapped portion in the second depth image 131 with the first depth image 111 as the third image 1311 according to the angle 15 between the first and second camera devices 11, 13. Thereby, as the above stable extremal regions overlap, the second image 1113 also overlaps the third image 1311 to generate the first overlapped image 5.

After the first overlapped image 5 is generated, the first image 1111, the first overlapped image 5, and the fourth image 1313 are displayed on the display unit 90. The driver of the vehicle 3 can know if there are objects nearby and the distance between the objects and the vehicle 3 according to the first image 1111, the first overlapped image 5, and the fourth image 1313 displayed on the display unit 90. According to the present disclosure, two depth images are overlapped and the overlapped portion in the images are overlapped. Consequently, the displayed range is broader and the viewing range blocked by the vehicle when the driver views outwards from the vehicle can be retrieved. Then the driver's blind spots can be reduced and thus improving driving safety. Hence, the method for overlapping images according to the first embodiment of the present disclosure is completed.

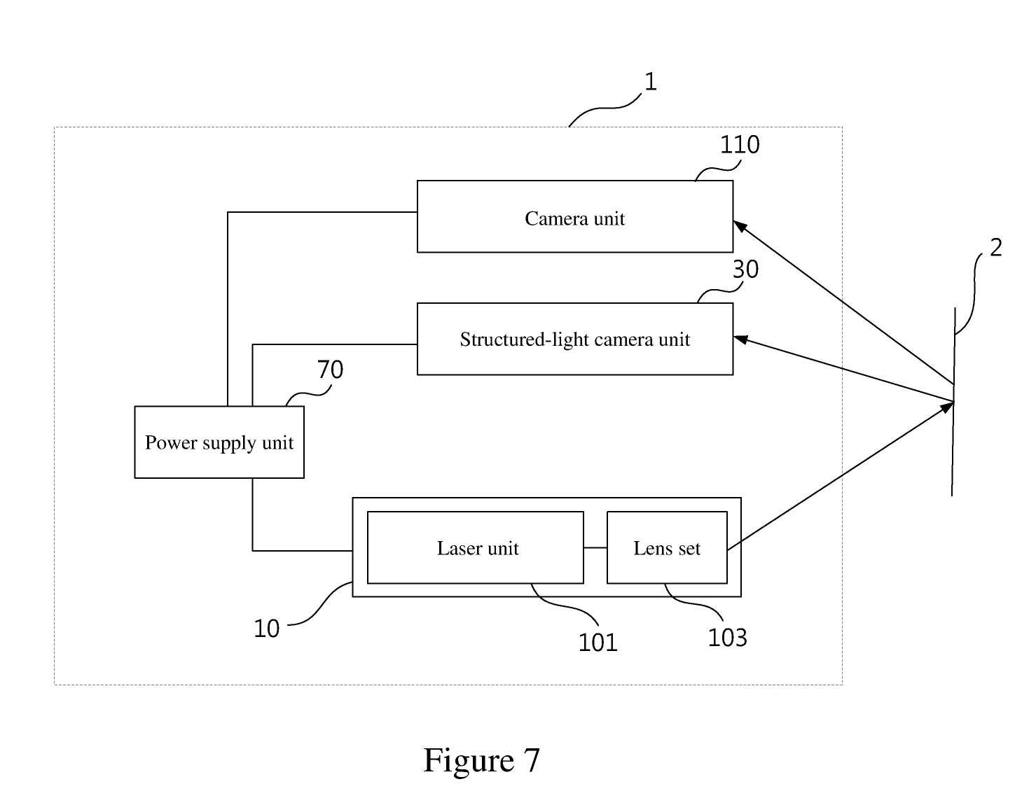

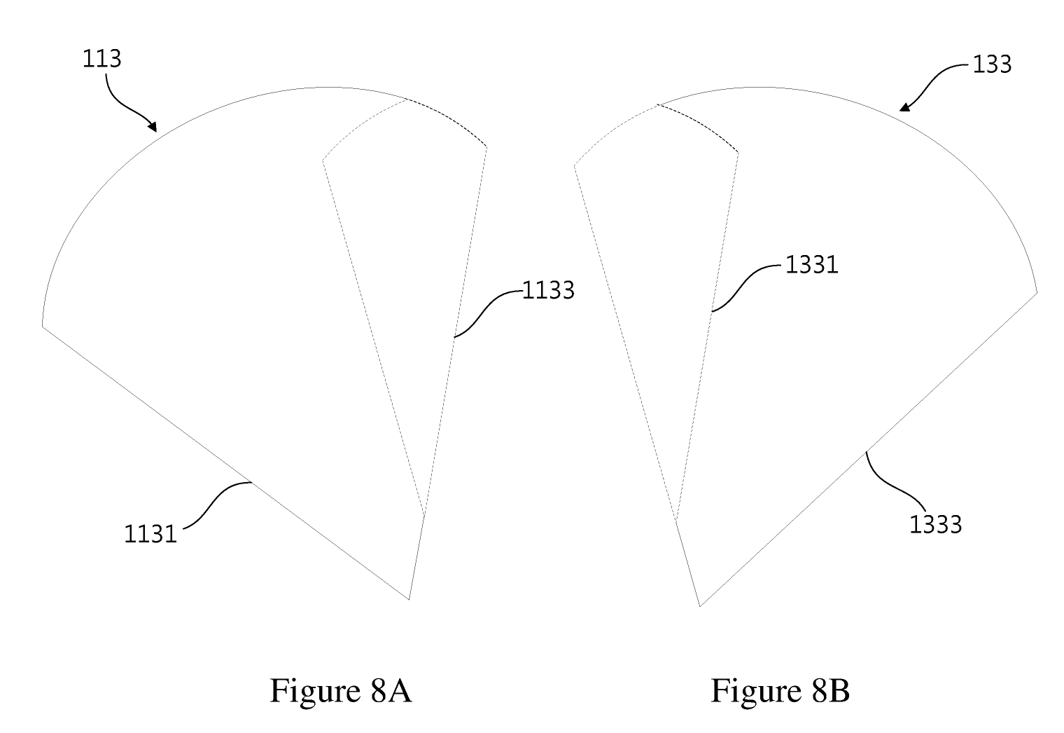

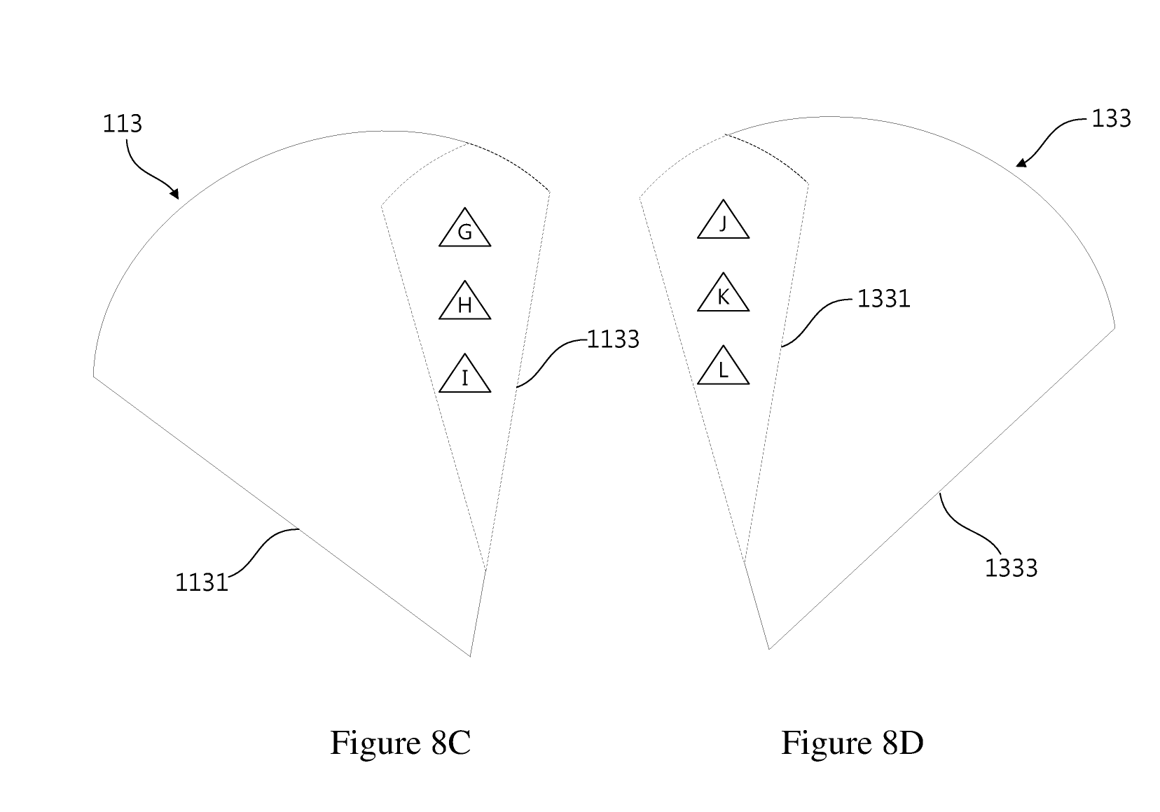

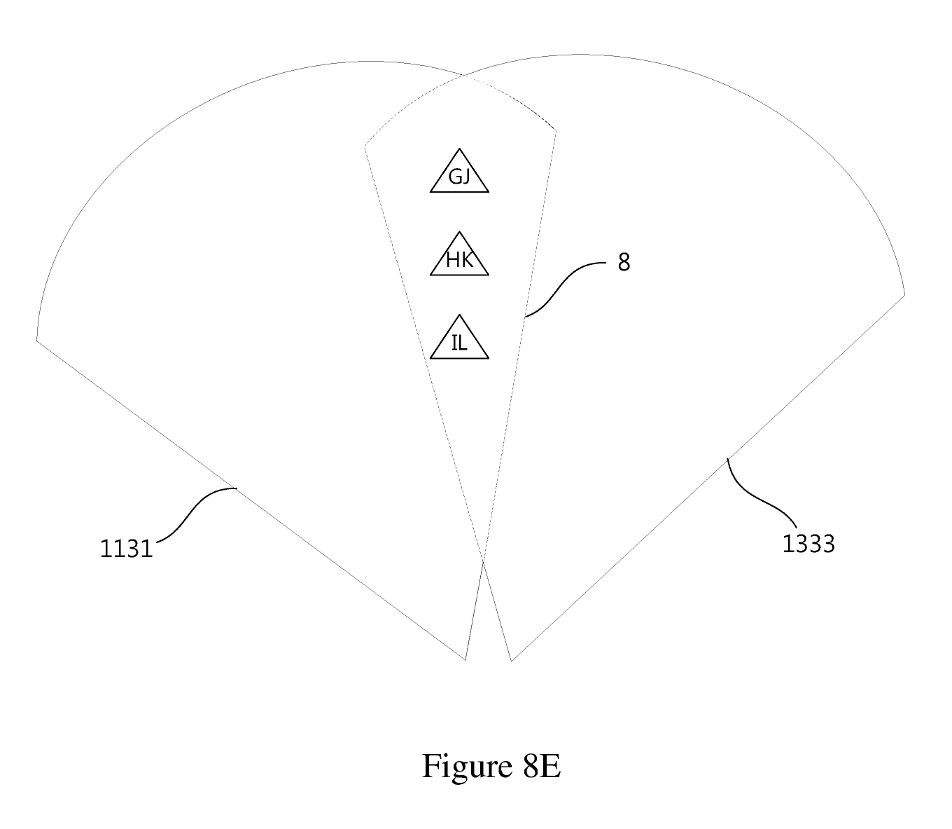

Next, the method for overlapping images according to the second embodiment of the present disclosure will be described below. Please refer to FIGS. 7 and 8A˜8E as well as FIGS. 1, 5A˜5C, and 6A˜6E. The difference between the present embodiment and the first one is that the camera device according to the present embodiment further includes a camera unit 110, which is a camera or other camera equipment capable of photographing a region and generating color images. The camera unit 110 is connected electrically with a power supply unit 70. According to the first embodiment, the driver can know the distance between the vehicle and an object via the structured-light images. Nonetheless, what displayed in the structures-light images is the outline of an object. It is not intuitive for the driver to judge if the object will endanger the vehicle according to the outline of the object. For example, the outlines of a pedestrian and a cardboard cutout are similar. However, a cardboard cutout won't threaten the safety of a vehicle. On the contrary, a moving pedestrian will. Thereby, the added camera unit according to the present embodiment can acquire color images. The driver can distinguish what the object is by the color images.

According to the second embodiment of the present disclosure, the step S1 is to acquire images. The structured-light camera unit 30 of the first camera device 11 generates a first depth image 111. The structured-light camera unit 30 of the second camera device 13 generates a second depth image 131. The camera unit 110 (the first camera unit) of the first camera device 11 generates a first color image 113; the camera unit 110 (the second camera unit) of the second camera device 13 generates a second color image 133. As shown in FIG. 8A, the first color image 113 includes a fifth image 1131 and a sixth image 1133. As shown in FIG. 8B, the second color image 133 includes a seventh image 1331 and an eighth image 1333.

According to the second embodiment of the present disclosure, the step S3 is to acquire characteristic values. The processing unit 50 adopts the MSER algorithm (the first algorithm) to calculate the second image 1113 to give a plurality of first stable extremal regions and calcite the third image 1131 to give a plurality of second stable extremal regions. The processing unit 50 adopts the maximally stable color regions (MSCR) algorithm (the second algorithm) to calculate the sixth image 1133 to give a plurality of first stable color regions and calculate the seventh image 1331 to give a plurality of second stable color regions. The MSCR algorithm calculates the similarity among neighboring pixels and combines the pixels with similarity within a threshold value to an image region. Then, by changing the threshold values, the relations of threshold variations among image regions, and hence the stable color regions, can be given. For example, as shown in FIG. 8C, the first color extremal region G, the first stable color region H, and the first stable color region I in the sixth image 1133 are given using the MSCR algorithm. As shown in FIG. 8D, the second stable color region J, the second stable color region K, and the second stable color region L in the seventh image 1331 are given using the MSCR algorithm.

According to the second embodiment of the present disclosure, the step S5 is to generate overlapped imaged. The processing unit 50 matches the first stable extremal regions A˜C of the second image 1113 to the second stable extremal regions D˜F of the third image 1311. Then the processing unit 50 generates a first overlapped image 5 according to the matched and overlapped second and third images 1113, 1311. The processing unit 50 matches the first stable color regions G˜I of the sixth image 1133 to the second stable color regions J˜L of the seventh image 1331. Then the processing unit 50 generates a second overlapped image 8 according to the matched and overlapped sixth and seventh images 1133, 1331. As shown in FIGS. 8C-8E, the first stable color region G matches the second stable color region J; the first stable color region H matches the second stable color region K; and the first stable color region I matches the second stable color region L. Thereby, when the processing unit overlaps the sixth and seventh images 1133, 1331, the processing unit 50 overlaps the first stable color G and the second stable color region J to generate a stable color region GJ, the first stable color region H and the second stable color region K to generate a stable color region HK, and the first stable color region I and the second stable color region L to generate a stable color region IL. Hence, the second overlapped image 8 is generated.

Because the first camera device 11 includes the first structured-light camera unit and the second camera device 13 includes the second structured-light camera unit, the processing unit 50 sets the overlapped portion in the first depth image 111 with the second depth image 131 as the second image 1113, the overlapped portion in the second depth image 131 with the first depth image 111 as the third image 1311, the overlapped portion in the first color image 113 with the second color image 133 as the sixth image 1133, and the overlapped portion in the second color image 133 with the first color image 113 as the seventh image 1331 according to the angle 15 between the first and second camera devices 11, 13.

After the first overlapped image 5 and the second overlapped image 8 are generated, the first image 1111, the first overlapped image 5, the fourth image 1313, the fifth image 1131, the second overlapped image 8, and the eighth image 1333 are displayed on the display unit 90. The first image 1111 overlaps the fifth image 1131; the first overlapped image 5 overlaps the second overlapped image 8; and the fourth image 1313 overlaps the eighth image 1333. The driver of the vehicle 3 can see the images of nearby objects and further know the distance between the objects and the vehicle 3. According to the present disclosure, the displayed range is broader and the viewing range blocked by the vehicle when the driver views outwards from the vehicle can be retrieved. Then the driver's blind spots can be reduced and thus improving driving safety. Hence, the method for overlapping images according to the second embodiment of the present disclosure is completed.

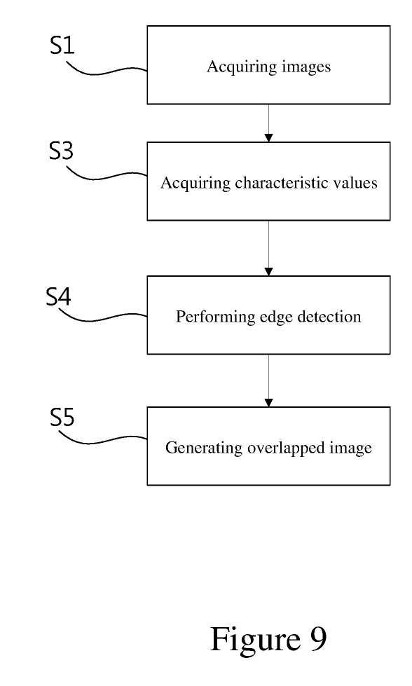

Next, the method for overlapping images according to the third embodiment of the present disclosure will be described. Please refer to FIG. 9, which shows a flowchart of the method for overlapping images according to the third embodiment of the present disclosure. The difference between the present embodiment and the previous one is that the process according to the present embodiment further comprises a step S4 for processing the characteristic regions using an edge detection algorithm. The rest of the present embodiment is the same as the previous one. Hence, the details will not be described.

The step S4 is to perform edge detection. The processing unit 50 performs edge detection on the second and third images 1113, 1311 or the sixth and seventh images 1133, 1331 using an edge detection algorithm. Then an edge-detected second image 1113 and an edge-detected third image 1311, or an edge detected sixth image 1133 and an edge-detected seventh image 1331, will be generated. The edge detection algorithm can be the Canny algorithm, the Canny-Deriche algorithm, the differential algorithm, the Sobel algorithm, the Prewitt algorithm, the Roberts cross algorithm, or other edge detection algorithms. The purpose of edge detection is to improve the accuracy while overlapping images.

According to the present embodiment, in a step S5, the processing unit 50 overlap the edge-detected second image 1113 and the edge-detected third image 1311 to generate the first overlapped image 5, or overlap the edge-detected sixth image 1133 and the edge-detected seventh image 1331 to generate the second overlapped image 8.

Hence, the method for overlapping images according to the third embodiment of the present disclosure is completed. By means of edge detection algorithms, the accuracy while overlapping the first overlapped image 5 or the second overlapped image 8 will be improved.

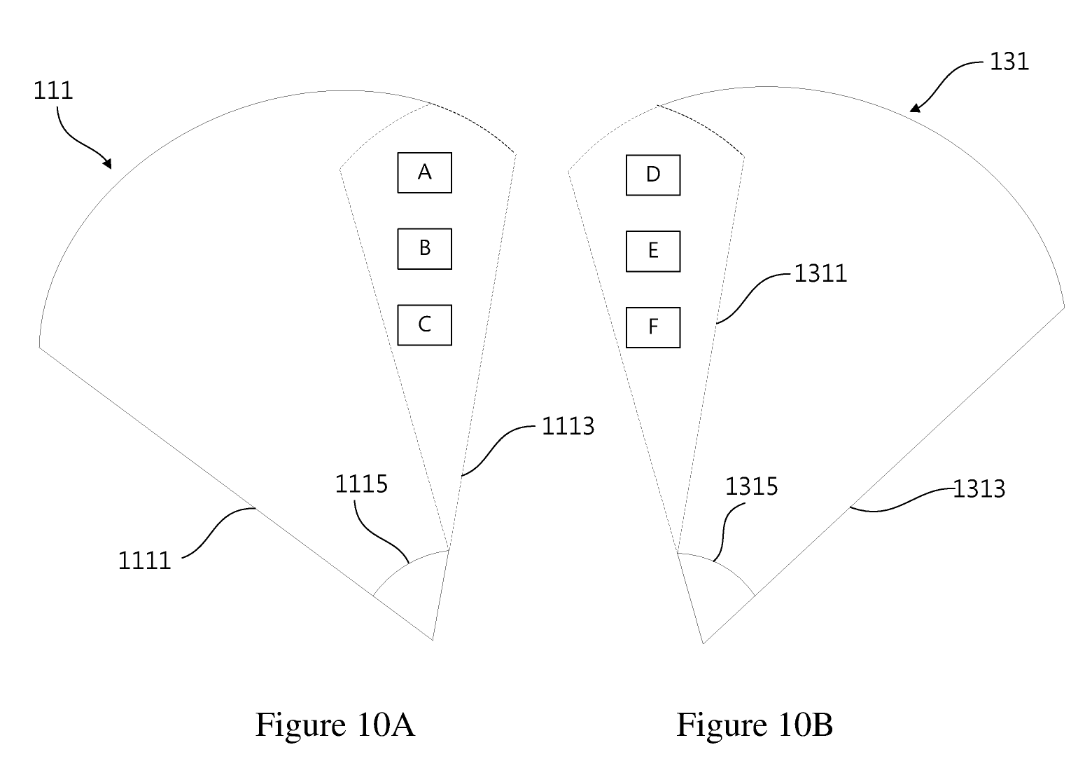

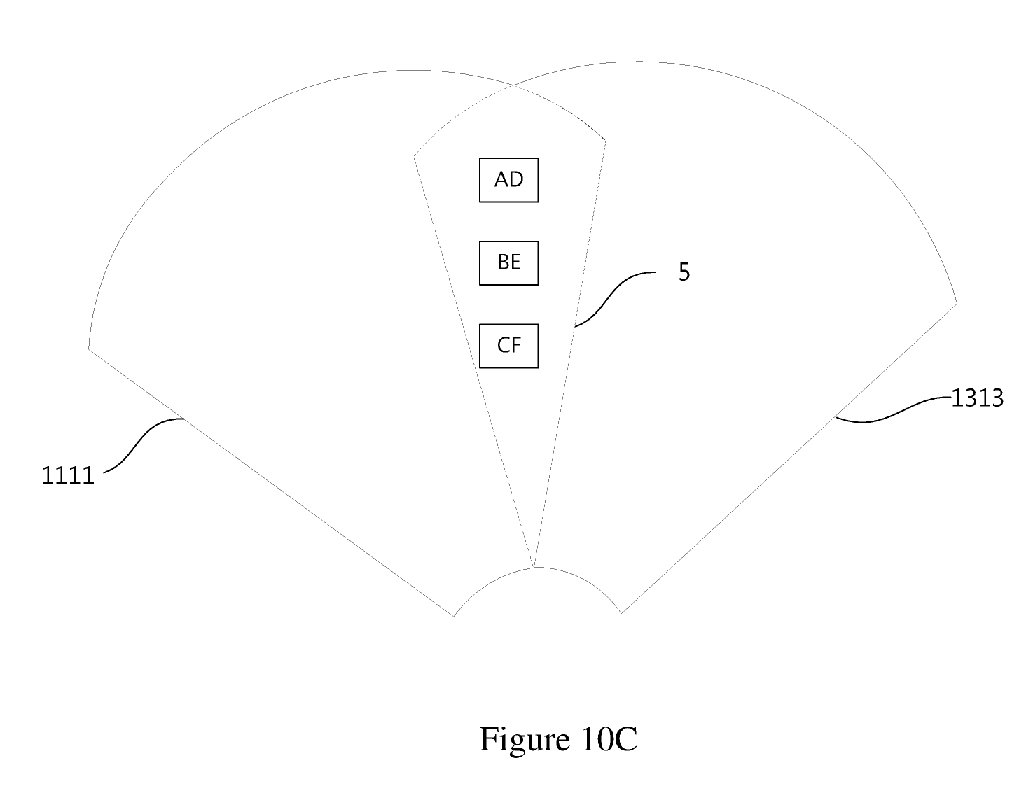

Next, the method for overlapping images according to the fourth embodiment of the present disclosure will be described. Please refer to FIGS. 10A to 10C. The processing unit 50 can eliminate the nearer image 1115 in the first depth image 111 and the nearer image 1315 in the second depth image 113 first for further acquiring the stable extremal regions and overlapping the second and third images 1113, 1311. The nearer images 1115, 1315 are the images closer to the vehicle 3. Thereby, the taken images are the interior of the vehicle 3 or the body of the vehicle 3. These images are less significant for the driver. Hence, they can be eliminated first for reducing the calculations of the processing unit 50.

According to an embodiment of the present disclosure, the nearer image 1115 includes the regions in the first depth image 111 with a depth between 0 and 0.5 meters; the nearer image 1315 includes the regions in the second depth image 113 with a depth between 0 and 0.5 meters.

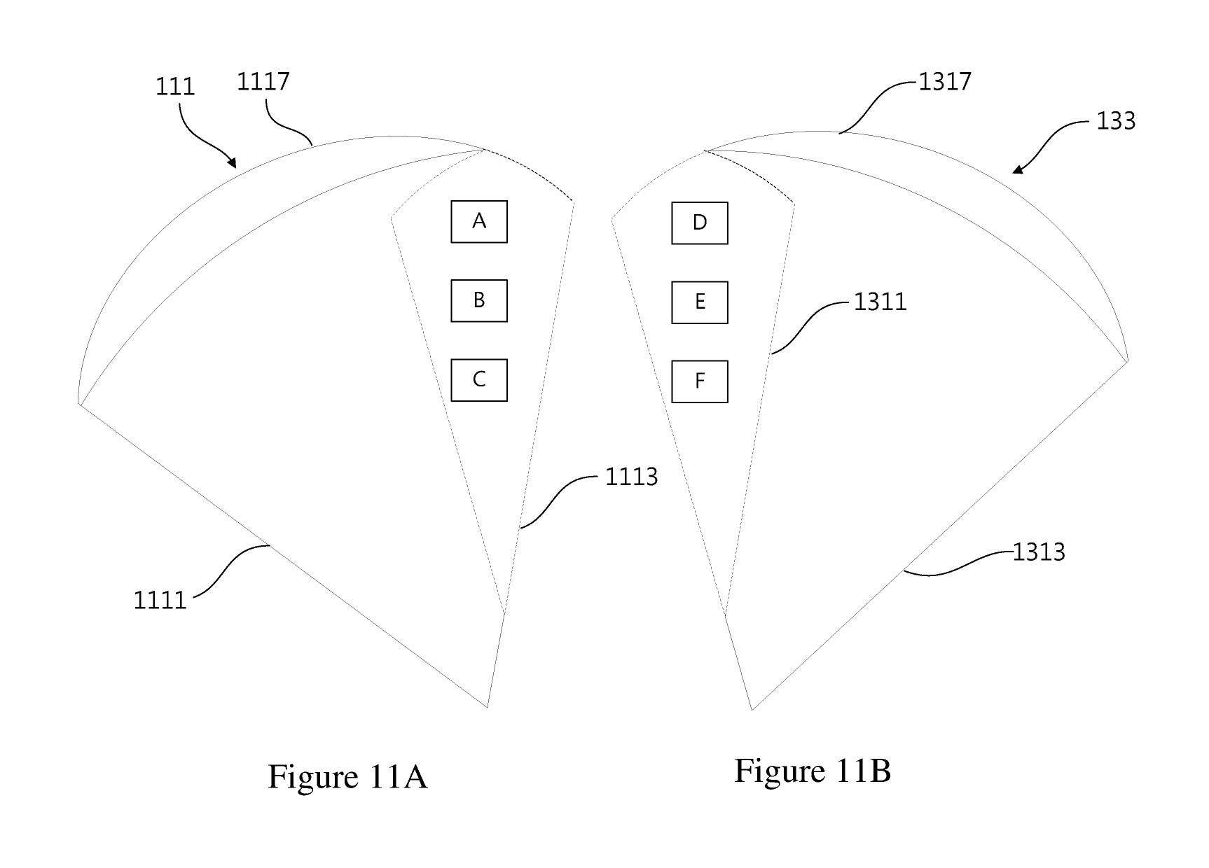

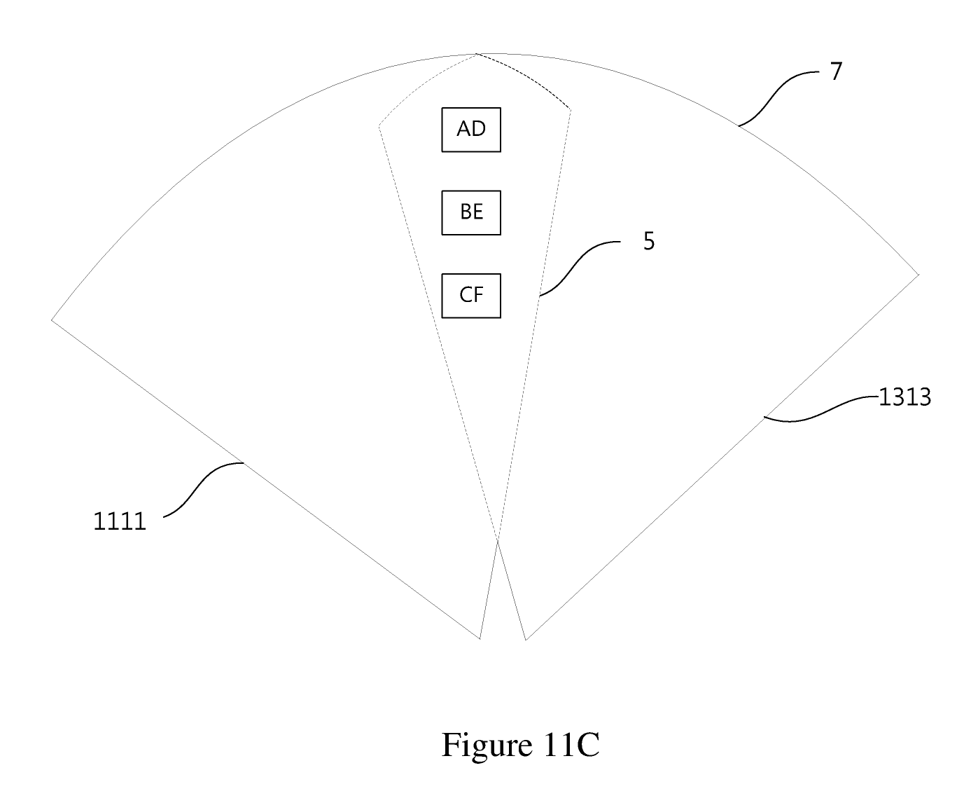

Next, the method for overlapping images according to the fifth embodiment of the present disclosure will be described. Please refer to FIGS. 11A to 11C. The processing unit 50 can eliminate the farther image 1117 in the first depth image 111 and the farther image 1317 in the second depth image 113 first for further acquiring the stable extremal regions and overlapping the second and third images 1113, 1311. The objects in the farther regions have no immediate influence for the vehicle 3 because they are away from the vehicle 3. Hence, they can be eliminated first for relieving the driver's load. Alternatively, the farther images 1117, 1317 taken by the structured-light camera units are less clear, making them less significant for the driver. Hence, they can be eliminated first for reducing the calculations of the processing unit 50.

According to an embodiment of the present disclosure, the farther image 1117 includes the regions in the first depth image 111 with a depth greater than 5 meters; the farther image 1317 includes the regions in the second depth image 113 with a depth greater than 5 meters. Preferably, the farther image 1117 and the farther image 1317 include the regions in the first depth image 111 and the second depth image 113 with a depth greater than 10 meters

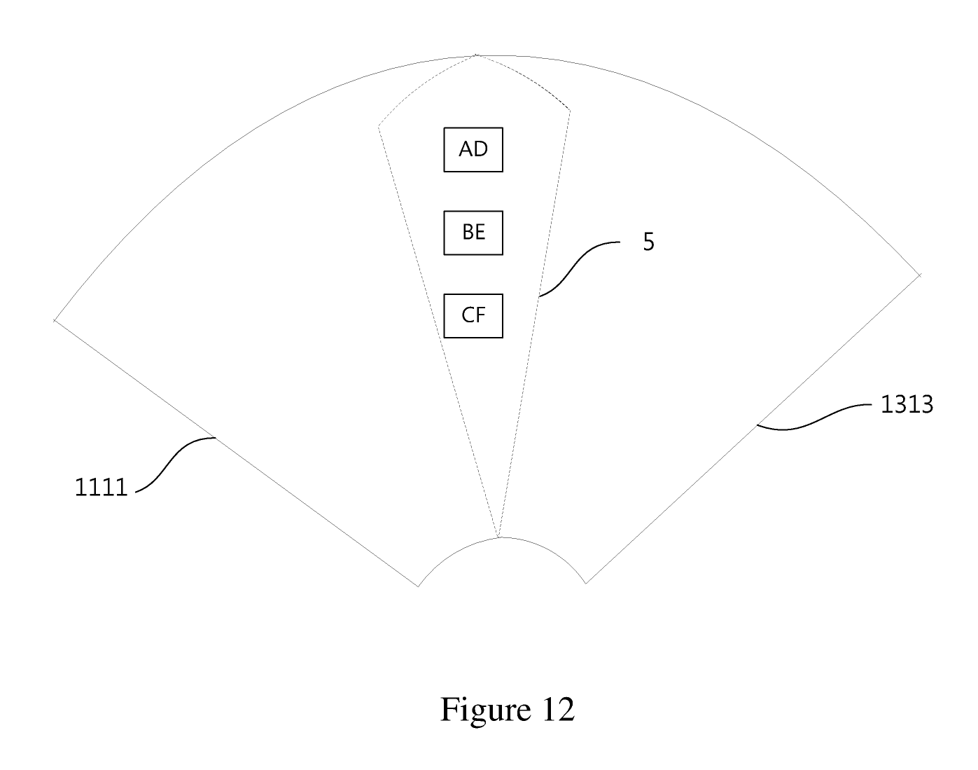

Next, the method for overlapping images according to the sixth embodiment of the present disclosure will be described. Please refer to FIG. 12 as well as FIGS. 10A, 10B, 11A, and 12B. The processing unit 50 can eliminate the nearer image 1115 in the first depth image 111 and the nearer image 1315 and the farther image 1317 in the second depth image 113 first for further acquiring the stable extremal regions and overlapping the second and third images 1113, 1311. Hence, the driver's load and the calculations of the processing unit 50 can be both reduced.

Accordingly, the present disclosure conforms to the legal requirements owing to its novelty, nonobviousness, and utility. However, the foregoing description is only embodiments of the present disclosure, not used to limit the scope and range of the present disclosure. Those equivalent changes or modifications made according to the shape, structure, feature, or spirit described in the claims of the present disclosure are included in the appended claims of the present disclosure.

What is claimed is:

1. A method for overlapping images, comprising steps of:
generating a first depth image using a first structured-light camera unit and generating a second depth image using a second structured-light camera unit, said first depth image including a first image and a second image, and said second depth image including a third image and a fourth image;
acquiring a plurality of first stable extremal regions of said second image and a plurality of second stable extremal regions of said third image according to a first algorithm; and
overlapping said second image and said third image to generate a first overlapped image, and displaying said first image, said first overlapped image and said fourth image on a display unit when said plurality of first stable extremal regions and said plurality of second stable extremal regions match.

2. The method for overlapping images of claim 1, further comprising a step of setting the overlapped portion in said first depth image with said second depth images as said second image and setting the overlapped portion in said second depth image with said first depth images as said third image according to the angle between said first structured-light camera unit and said second structured-light camera unit.

3. The method for overlapping images of claim 1, wherein said first algorithm is the maximally stable extremal regions (MSER) algorithm.

4. The method for overlapping images of claim 1, further comprising steps of:
generating a first color image using a first camera unit and generating a second color image using a second camera unit, said first color image including a fifth image and a sixth image, and said second color image including a seventh image and an eighth image;
acquiring a plurality of first stable color regions of said sixth image and a plurality of second stable color regions of said seventh image according to a second algorithm; and
when said plurality of first stable color regions and said plurality of second stable color regions match, overlapping said sixth image and said seventh image to generate a second overlapped image, and displaying said fifth image, said second overlapped image, and said eighth image on said display unit.

5. The method for overlapping images of claim 4, further comprising a step of setting the overlapped portion in said first color image with said second color images as said sixth image and setting the overlapped portion in said second color image with said first color images as said seventh image according to the angle between said first camera unit and said second camera unit.

6. The method for overlapping images of claim 4, further comprising a step of processing said sixth image and said seventh image using an edge detection algorithm and generating an edge-detected sixth image and an edge-detected seventh image.

7. The method for overlapping images of claim 4, wherein said second algorithm is the maximally stable color regions (MSCR) algorithm.
